(19) United States
(12) Patent Application Publication
(10) Pub. No.: US 2015/0347993 A1
(43) Pub. Date: Dec. 3, 2015

(54) Electronic Funds Transaction System And Method

(71) Applicant: REDMOND COMPANY PTY LTD, Wollongong, New South Wales (AU)

(72) Inventors: Geoffrey Redmond, Caringbah, New South Wales (AU); Martin Cooperwaite, Melbourne, Vicoria (AU); Sam Kroonenburg, Melbourne, Victoria (AU)

(73) Assignee: Redmond Company Pty Ltd., Wollongong, New South Wales (AU)

(21) Appl. No.: 14/651,741

(22) PCT Filed: Dec. 6, 2013
(86) PCT No.: PCT/AU2013/001417

§ 371 Date: Jun. 12, 2015

(30) Foreign Application Priority Data
Dec. 12, 2012 (AU) 2012905415

(51) Int. Cl. G06Q 20/10; G06Q 20/40

(52) U.S. Cl. CPC G06Q 20/10; G06Q 20/405

(57) ABSTRACT

An electronic funds transfer system comprising: at least one user account, each of which is associated with a user of the system; at least one partner organisation account, each of which is associated with a partner organisation of the system; a system administrator adapted to receive notification from said partner organisation of funds to be transferred to said user account; and a provider fund containing funds for financing transactions between said partner organisation and said user, wherein said system administrator, on receiving an electronic funds transfer notification from a partner organisation, is adapted to directly or indirectly facilitate transfer of an allocated fund notified by said partner organisation to an allocated user account in real time in anticipation of receipt of the allocated fund by said provider fund from a partner organisation funds manager after clearance of the allocated fund from said partner organisation funds manager.

### FIELD OF INVENTION

The present invention relates to an electronic funds transaction system and method. In particular, the invention relates to an electronic system that includes a provider fund, also referred to herein as a “float”, which may be used to facilitate immediate payment of funds from a partner organisation to a user of the system foregoing conventional waiting periods associated with fund transfers from financial institutions and the like.

### BACKGROUND ART

Numerous electronic transaction systems for facilitating payments and transfers of fund online are known and are currently in use.

The largest and most recognised money transfer platform is PayPal. This platform is a global e-commerce service that facilitates payments and money transfers over the Internet. With a very wide global reach, PayPal has a revenue of $US4.4 billion (2011) and operates in 190 markets, supporting over 230 million accounts. While PayPal provides Prepaid MasterCard facilities for users in the United States who have a PayPal account, PayPal is more often used as a payment processing service for online vendors. Transferring funds from a regular bank account to a PayPal account may take from 3 to 4 business days and weekends or public holidays may delay the transfer of funds further. Transfers to PayPal accounts using VISA or MasterCard are instantaneous. For this service PayPal charges a 2.9% transaction fee on the total sale and a $0.30 fee per transaction, while internationally sellers are charged a 3.9% transaction fee and another fixed fee based on the currency received. Similarly, when money needs to be deposited from PayPal back into a bank account it may lake several business days to do so. Transfer of funds from businesses or merchants to a PayPal user can take up to 24 hours to process. Transferring money from PayPal to another account, either another PayPal account or bank account may also attract fees. Using a credit/debit card via the PayPal network in the United States may attract a 2.9% fee and $0.30 fee per transaction. Outside the US, a fee of 0.5% to 2% applies when the transfer is funded with a bank account or a PayPal balance. A fee of 3.4% to 3.9% applies if the transfer is funded with a credit or a debit card.

Neteller is another popular online payment and money transfer service through which money can be transferred to Neteller from a bank, credit or debit card or via other online methods. This service can be used to pay merchants and also provides a debit MasterCard that can be used to withdraw money from automatic teller machines (ATMs) or pay for goods and services. Neteller also allows money withdrawal via a bank transfer or cheque. As with PayPal, Neteller can be used to receive payments directly from merchants. While Neteller states that fund transfers to merchants range from instant to 48 hours, the transfer of funds from merchants to Neteller users may take much longer. For example, Neteller states that in some cases transfers may take up to 7 days. There are some merchants that claim a 1 hour time frame for money transfer when Neteller is used. However, in practice the waiting period can be close to 2 hours. Most merchants, however, quote 24 hours for transfers. Neteller charges different fees for deposits and withdrawals. Deposits to a Neteller account from a bank account are free, but from a MasterCard or VISA the fee is 1.75% to 4.95%. Withdrawing money from a pre-paid Neteller MasterCard can involve charges of up to $EU4.0 while a bank transfer involves charges of $EU7.5. A bank transfer to withdraw funds generally takes from 3 to 5 business days.

Skrill Moneybookers is another more recent but popular e-commerce service that allows payments to be made over the Internet. Similarly to Neteller, the system offers a “digital wallet” that safely stores user's money. Moneybookers allows sending and receiving money internationally in 40 currencies and works in over 200 countries accepting local payment options. A prepaid MasterCard is offered by Moneybookers for instant access to funds and users can add funds to their accounts via a bank transfer or their VISA or MasterCard. Bank deposits to Moneybookers are free but take several days to carry out. Depositing via a VISA/MasterCard is instant but it incurs a fee of 1.9%. Sending money from an organisation (such as a merchant) to a Moneybookers account takes 24 hours to carry out. Withdrawing money from Moneybookers to a bank account involves a fee of $EU1.85. The fee is $EU3.50 if money is withdrawn using a cheque and $EU1.80 to a VISA card. Cash withdrawal from Moneybookers' own prepaid MasterCard involves a fee of $EU1.80.

There are a number of similar online payment platforms, such as EntroPay and iKobo. Many of these payment platforms offer a prepaid VISA or MasterCard that can be leveraged to withdraw funds. However, all of these services take up to 24 hours for money to be transferred from a merchant to the user and charge for transfers and withdrawals are involved.

It would be advantageous if a system could be provided that offers an instant funds deposit service that provides users with seemingly instant deposits from partner organizations to their accounts without delays of 24 hours or more, as experienced with existing systems.

The subject matter claimed herein is not limited to embodiments that solve any disadvantages or that operate only in environments such as those described above. Rather, this background is only provided to illustrate one exemplary technology area where some embodiments described herein may be practice.

### SUMMARY OF INVENTION

The present invention relates to an electronic funds transaction system and method. In particular, the invention relates to an electronic system that includes a provider fund, also referred to herein as a “float”, which may be used to facilitate immediate payment of funds from a partner organisation to a user of the system foregoing conventional waiting periods associated with fund transfers from financial institutions and the like.

One aspect of the present invention provides an electronic funds transfer system comprising:
at least one user account, each of which is associated with a user of the system;
at least one partner organisation account, each of which is associated with a partner organisation of the system;
a system administrator adapted to receive notification from the partner organisation of funds to be transferred to the user account; and
a provider fund containing funds for financing transactions between the partner organisation and the user,
wherein the system administrator, on receiving an electronic funds transfer notification from a partner organisation, is adapted to directly or indirectly facilitate transfer of an allocated fund notified by the partner organisation to an allocated user account in real time in anticipation of receipt of the allocated fund by the provider fund from a partner organisation funds manager after clearance of the allocated fund from the partner organisation funds manager.

As used herein the term “real time” includes within its scope immediate or instant transaction. The term also includes delayed transaction, generally minimally delayed transaction, for example where the speed of transaction is dependent on the speed or connectivity of the network being utilised.

In a preferred embodiment, the system administrator is not responsible for the physical movement of funds between accounts, although this may be possible in some alternative embodiments. Rather, the system administrator is preferably adapted to instruct a platform provider to effect the transfer of the allocated funds from the provider fund to the user account. In this embodiment, the system administrator preferably maintains a ledger of the user account and the partner organisation account.

In order to extend functionality of the system, generally each the user of the system is allocated a credit card facility, preferably a debit card facility (i.e. prepaid credit card facility), associated with the user account to provide instant access to user funds held in the user account to the user. This advantageously enables transactions between users of the system and organisations, including but not limited to merchants, banks and funds, and government organisations, using existing credit card networks. It is envisaged that the credit or debit card may be a VISA prepaid card.

The partner organisation funds manager holds funds of the partner organisation. Generally, the partner organisation funds manager may be a financial institution having a funds clearance period of 24 hours or more. As such, transfer of the allocated fund by the provider fund to the user effectively brings forward receipt of payment to the user by 24 hours or more.

Although some delay in transfer of the allocated fund to the allocated user's account may be acceptable, for example to system connectivity and/or speed and so on, it is preferred that the transfer of the allocated fund to the allocated user account is substantially instantaneous on receipt of the electronic funds transfer notification from the partner organisation.

Generally, it is preferred that the provider fund contains an amount of funds dependent on the overall volume of transactions that occur, or that are expected to occur within the system, and/or if the provider fund is depleted the system defers transfer of the allocated fund notified by the partner organisation to the allocated user account until clearance of the allocated fund from the partner organisation funds manager. This advantageously ensures that the system provider fund does not over-extend its credit to partner organisations.

In order to overcome issues relating to transaction processing speed, the system preferably comprises a plurality of transaction processing nodes wherein each node is responsible for one distinct operation in the transaction process. The nodes do not communicate with one another. Rather, the nodes preferably communicate indirectly via a high speed event bus. In one embodiment the Event Bus is logical, preferably composed of a set of Windows Azure Service Bus Queues.

In another aspect the invention provides a method for electronic transfer of funds comprising:
notifying a system administrator of an electronic funds transfer from a partner organisation to an allocated user account;
transferring an allocated fund notified by the partner organisation from a provider fund to, the allocated user account in real time in anticipation of receipt of the allocated fund by the provider fund from a partner organisation funds manager; and
transferring an amount corresponding to the allocated amount to the provider fund from the partner organisation funds manager after clearance of the allocated fund from the partner organisation funds manager.

In a preferred embodiment, on receiving notification of the electronic funds transfer the system administrator instructs a platform provider to effect the transfer of the allocated funds from the provider fund to the allocated user account.

As with the system described above, it is preferred that the transfer of the allocated fund to the allocated user account be substantially instantaneous on receipt of the electronic funds transfer notification from the partner organisation. However, some delays may be acceptable in certain circumstances.

Again, the partner organisation funds manager may generally be a financial institution having a funds clearance period of 24 hours or more.

According to embodiments of the method, each distinct operation during transaction processing is processed by an independent transaction processing node, wherein when a node finishes its processing it fires an event to invoke the next node in the transaction processing. Again, preferably the nodes communicate indirectly via a high speed event bus.

In another aspect the invention provides a method of administering an electronic transfer of funds comprising:
receiving notification of an electronic funds transfer from a partner organisation to an allocated user account; and
instructing a platform provider to effect the transfer of an allocated fund notified by the partner organisation from a provider fund to the allocated user account in anticipation of receipt of the allocated fund by the provider fund from a partner organisation funds manager,
whereby the allocated fund is credited to the allocated user account in real time.

The allocated fund is generally credited to the allocated user account 24 hours or more prior to clearance of the allocated fund by the partner organisation funds manager. That is, the electronic funds transfer is substantially instantaneous while a conventional transaction may take 24 hours or more.

In a preferred embodiment, the method additionally comprises maintaining a ledger of the user account. Of course, in practice it is envisaged there will be many users and as such the method generally comprises maintaining a ledger of all user accounts.

Again, according to embodiments of the method, each distinct operation during transaction processing is processed by an independent transaction processing node, wherein when a node finishes its processing it fires an event to invoke the next node in the transaction processing. Again, preferably the nodes communicate indirectly via a high speed event bus.

The present invention consists of features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF ACCOMPANYING DRAWINGS

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

FIG. 1 illustrates an electronic funds transfer system of an embodiment of the invention.

FIG. 2 illustrates a flow chart of a method for electronic transfer of funds of an embodiment of the invention.

FIG. 3 illustrates a conventional transaction process.

FIG. 4 illustrates a processing pipeline according to an embodiment of the invention.

FIG. 5 illustrates a node in the processing pipeline of FIG. 4.

FIG. 6 illustrates the processing pipeline of FIG. 4 in more detail.

FIG. 7 illustrates completion of a transaction using the processing pipeline of FIG. 4.

FIGS. 8A to 8D illustrate a crash of one part of the processing pipeline and the recovery process.

FIG. 9A to 9C illustrate elastic scaling of the system of an embodiment of the invention.

### DETAILED DESCRIPTION OF THE PREFERRED EMBODIMENTS

The present invention provides an electronic funds transaction system and method. In particular, the invention relates to an electronic system that includes a provider fund, also referred to herein as a “float”, which may be used to facilitate immediate payment of funds from a partner organisation to a user of the system foregoing conventional wailing periods associated with fund transfers from financial institutions and the like.

Hereinafter, this specification will describe the present invention according to the preferred embodiments. It is to be understood that limiting the description to the preferred embodiments of the invention is merely to facilitate discussion of the present invention and it is envisioned without departing from the scope of the appended claims.

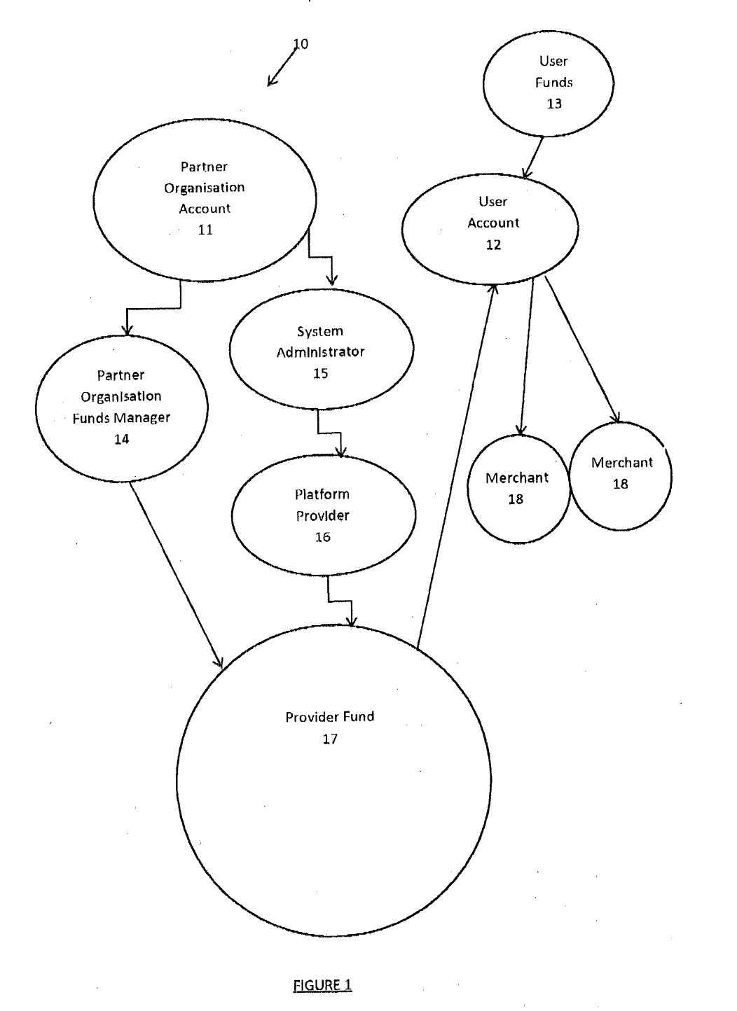

Referring to FIG. 1, an electronic funds transfer system 10 is illustrated. The system 10 includes at least one partner organisation account 11 associated with a partner organisation that has integrated with the system 10. Of course, it is anticipated that a plurality of partner organisations will integrate with the system 10 resulting in a plurality of associated partner organisation accounts 11. The system 10 also includes at least one user account 12 associated with a user of the system 10. Again, it is anticipated that there will be numerous users of the system and, therefore, numerous associated user accounts 12. A single partner organisation account 11 and a single user account 12 are illustrated for clarity and convenience.

The user account 12 may be accessed by the user and topped up with user funds 13, as discussed in more detail below. In certain embodiments, the user account is associated with a prepaid credit card which may be used for payment of goods or services to merchants 18.

Funds of the partner organisation 11 are held by a partner organisation funds manager 14, which is generally a financial institution. The partner organisation account 11 is in communication with the partner organisation funds manager 14 and a system administrator 15 and can therefore notify both the partner organisation funds manager 14 and the system administrator 115 of any funds transfer to be made to a user account 12.

On receiving notification from the partner organisation account 11 of a funds transfer to be made to a user account 12, the partner organisation funds manager 14 proceeds in the usual manner to arrange for clearance of the funds. As with conventional financial institutions, such clearance may traditionally take 24 hours or more. In the meantime, on receiving the notification from the partner organisation account 11 the system administrator 15 is adapted to instruct a platform provider 16 to transfer the funds notified by the partner organisation account 11 from a provider fund 17 into the user account 12 in real time, generally substantially instantaneously. This gives the impression of immediate payment of the funds from the partner organisation account 11 to the user account 12. The partner organisation funds manager 14 is adapted to reimburse the funds to the provider fund 17 through the platform provider 16 when the funds have been cleared by the partner organisation funds manager 14, generally 24 hours or more later.

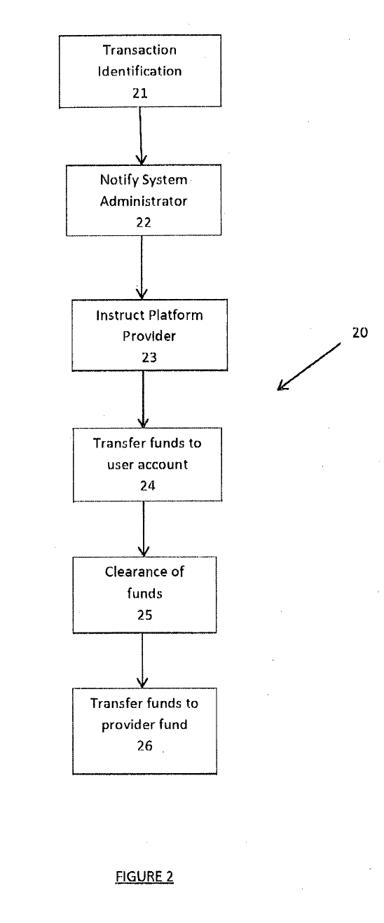

Turning to FIG. 2, a method for electronic transfer of funds 20 is illustrated. The method 20 involves the initial identification of a transaction 21 to be made. This is generally identified by the partner organisation and includes identifying an amount of funds to be electronically transferred to the user account 12.

Once identification of the transaction 11 is achieved, the partner organisation notifies 22 the system administrator 15 of the transaction. The system administrator 15 then Instructs 23 the platform provider 16 to immediately transfer the required funds 24 to the allocated user account 12. Effectively, the provider fund 17 acts as a short term loan facility for the amount required.

The partner organisation also confirms the transfer of funds with the partner organisation funds manager 14 that is in control of the partner organisation funds. The partner organisation funds manager 14 than attends to clearance of the funds 24 to be transferred, a process that traditionally takes 24 hours or more. The partner organisation funds manager 14 then transfers the funds 25 to the provider fund 17 through the platform provider 16, effectively reimbursing the provider fund 17 and completing the transaction.

Various features and steps of the system and method will now be described in more detail. As used hereafter, the term “iPay” will be used to identify the system 10 and method 20 of the invention.

### Overview

The iPay system 10 is a streamlined, intuitive and trusted online system that handles electronic fund transfers. It can be used via a smartphone on a platform of choice, for example an iPhone, Android or Windows Phone, or accessed via the web portal from any computer. The only requirement for operation of iPay is the availability of an Internet connection.

The iPay users must initially create an iPay user account 12 via a process sufficient to allow the receipt of a Visa Prepaid Card. Once the iPay user receives a VISA prepaid card with an accompanying iPay user account 12 and account number in a welcome package, the user is then able to perform the actions outlined below.

### Top Up

The iPay user can top up their iPay user account 12 directly using a pre-existing credit or debit card. The user enters their card information and the amount to transfer over. The amount is instantly added to their iPay user account 12 balance and is available immediately for use.

### Automatic Top Up

The iPay user can set the system 10 up to automatically top up their iPay user account 12 from a different funding source if it drops to a predefined minimal threshold. For example, the user may choose to automatically deposit $100 to their iPay user account 12 if it falls under $25. The lop up can come from a nominated credit card or bank account (i.e. the user funds 13).

### Withdrawal of Funds

An iPay user can withdraw funds from their iPay user account 12 at any time using their iPay VISA Prepaid card. This is a regular VISA Prepaid card and can be used at an automatic teller machine (ATM), in shops or online.

### Configure Account/View History

The iPay user can also configure their iPay user account 12, for example linking a new credit card, view transaction history or change pertinent information such as their address.

Depositing from iPay to an Organisation

Most organisations in Australia, and Indeed globally, that deal with financial transactions including and not limited to merchants, banks and funds, and government organisations, allow the use of MasterCard and VISA for deposit to their accounts. With the iPay system 10, the user uses the iPay provided VISA Prepaid card to transfer money from their iPay user account 12 to the organisation of their choice. As fund transfers are currently taken care of by the VISA network, no integration is required between iPay and the organisation. This process is therefore seamless and familiar.

Depositing from a Partner Organisation to iPay

If an iPay user decides to deposit their money from a partner organisation, such as a merchant, or a government department, back to their iPay user account 12, this process is carried out in the same manner that the user is familiar with. The iPay user requests that the partner organisation transfer the required amount to their iPay user account 12, just as they normally would to their personal bank account. The partner organisation's system calls iPay programmatically to notify that the iPay user's fund transfer has been sent. iPay immediately credits the Pay user account 12 with the required amount, on behalf of the partner organization. The iPay user is then able to transfer their money from iPay to a different organisation, keep it in the account or withdraw it. The next business day, the bank clears the transfer and deposits the actual funds to iPay. The whole experience, including depositing funds from a partner organisation, to iPay is continuous and transparent to the iPay user.

### The “Float”

The system takes advantage of a “float”, the provider fund 15 provided by iPay, to extend short-term credit to partner organisations who are making payments to iPay users, and which are yet to clear. This fund is used to credit the user's iPay user account 12 immediately and is replenished when the user's funds are cleared by the bank. The size of the float depends on the overall volume of transactions that occur within the system. If the float is depleted then iPay slops extending the short-term credit until the iPay partner organisation's transactions clear and the fund is refilled. Effectively this guarantees that iPay never over-extends its credit. It only credits iPay users' accounts while there are funds. In the worst case, the iPay user might have to wait the payment clearance period to receive their funds if the float is depleted. This is no worse than the current payment systems. In practice this should never occur, or happen very rarely in accordance with the financial modelling of the iPay system.

### Fraudulent Activity

Financial services organisations always carry a risk of fraudulent activity. The main risk factor in the iPay system 10 is a compromised partner organisation. In order to defraud iPay, an attacker must have access to an iPay user account 12 and gain unauthorized access inside the partner organisation. For the attacker to evade identification, they must first have created an iPay user account 12 using fraudulent identification or hijacked a valid iPay user account 12 without the user's knowledge. Via the unauthorized access to the partner organisation, the attacker would have to inform iPay using its integration channel and compromised partner credentials that funds are to be transferred to the compromised iPay user account 12 and that these funds are being cleared by their bank, but the funds are never actually notified to the bank or sent. The attacker could then withdraw money from iPay before the attack is detected and before a hold placed on the compromised iPay user account 12. To contend with these issues, iPay will securely encrypt and authorize all communications with third parties.

### Processing Throughput

The iPay platform is a high speed transaction based processing system that may advantageously leverage cloud computing in a manner that overcomes existing data storage throughput limitations of cloud processing and storage.

Transaction processing in the cloud is currently performed in a serialised fashion as illustrated in FIG. 3. That is, each process is an end to end transaction request 300 performed in sequence. This requires multiple writes to a database 310 and consists of complex logic for recovery from any fault during the transaction process.

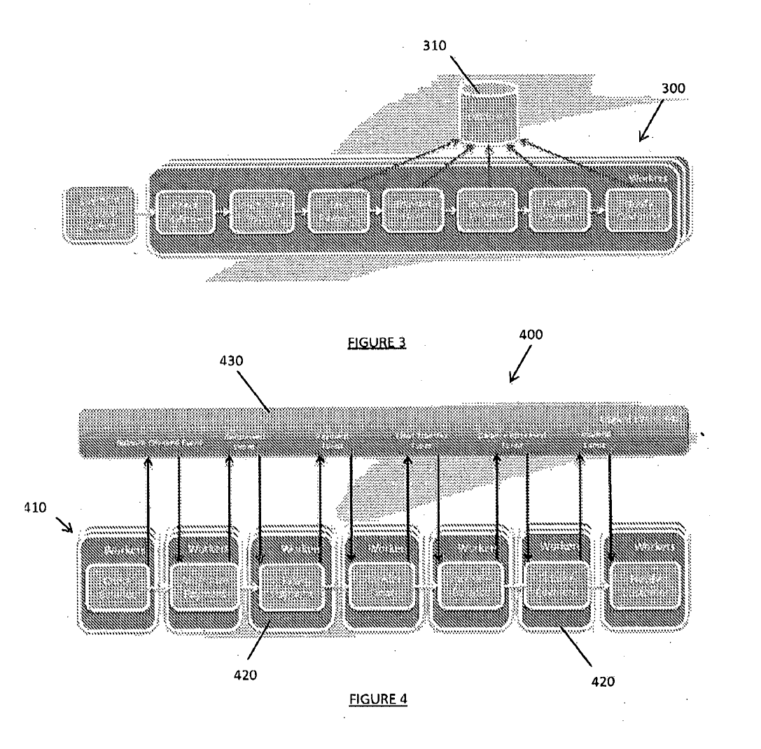

Embodiments of the iPay platform improve on the existing serialised approach to transaction processing in the cloud with an event driven architecture to transaction processing. This is achieved with parallelism which facilitates running of multiple pipelines simultaneously with a single thread handling the processing of a transaction from end to end. This is illustrated in FIGS. 4 through 9, and is discussed in more detail below.

In certain embodiments, the iPay system is built on the following platforms on Microsoft Azure Cloud Network:
Service Bus Queues
Service Bus Topics
Table Storage
SQL Azure Federations

In certain embodiments, the software solution consists of:
A Montioring Agent
Logical Event Bus based on MS Azure Service Bus Queues
Logical Worker Nodes

The transaction process 400 is separated into a pipeline 410 of independent transaction processing nodes 420 where each node 420 is responsible for one distinct operation in the transaction process 400. The nodes 420 never talk to each other, but communicate indirectly via a high speed event bus 430. When a node 420 finishes its work, it fires an event to invoke the next node 420 in the processing pipeline 410.

Each node 420 has a distinct responsibility and can be tweaked to gain higher throughput for the operation it performs. For example, as illustrated in FIG. 5, authorised events 540 such as payment authorisations may be batched at a take payment node 520. Once a predetermined number of events is received, these may be dispatched as a batch for payment via an external payment gateway 550. This will fire payment events 560 for the batch.

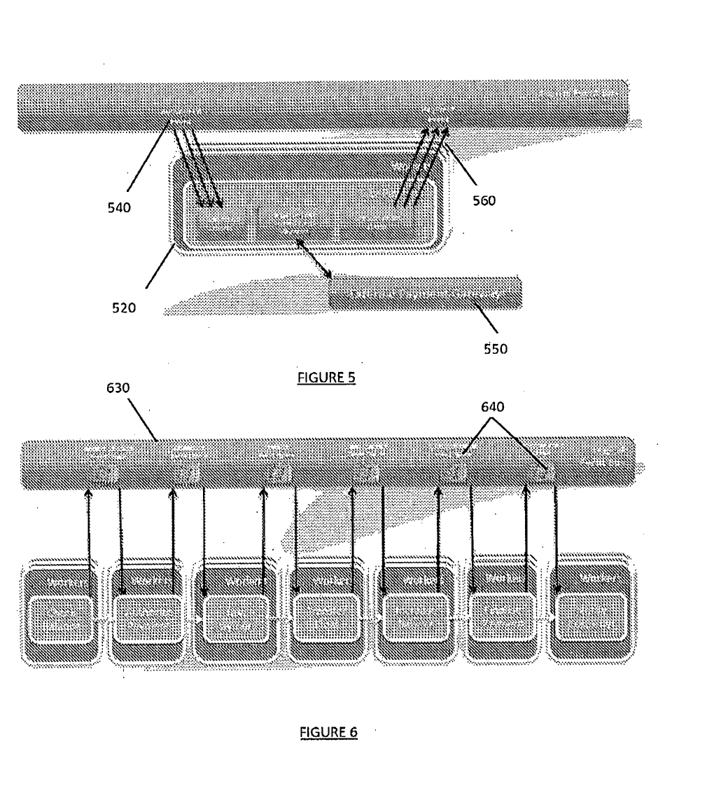

FIG. 6 illustrates the event bus 630 in more detail. The event bus 630 is logical. It is composed of a set of Windows Azure Service Bus Queues 640. These are durable and highly available.

Referring to FIG. 7, only one write 710 to SQL 720 is required when a transaction Is finalized. Therefore, efficiency is improved as only one write per transaction is required. In addition, writes to SQL 720 can be batched, to achieve dramatically increased throughput. If any part of the system crashes, it recovers automatically. The other nodes continue processing events as discussed in more detail below.

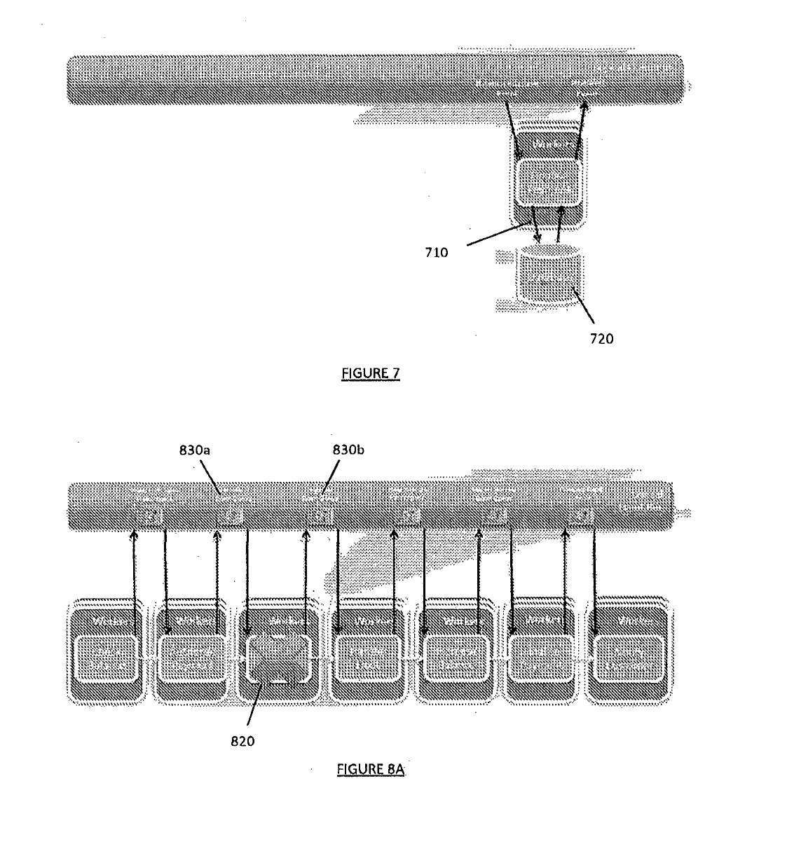

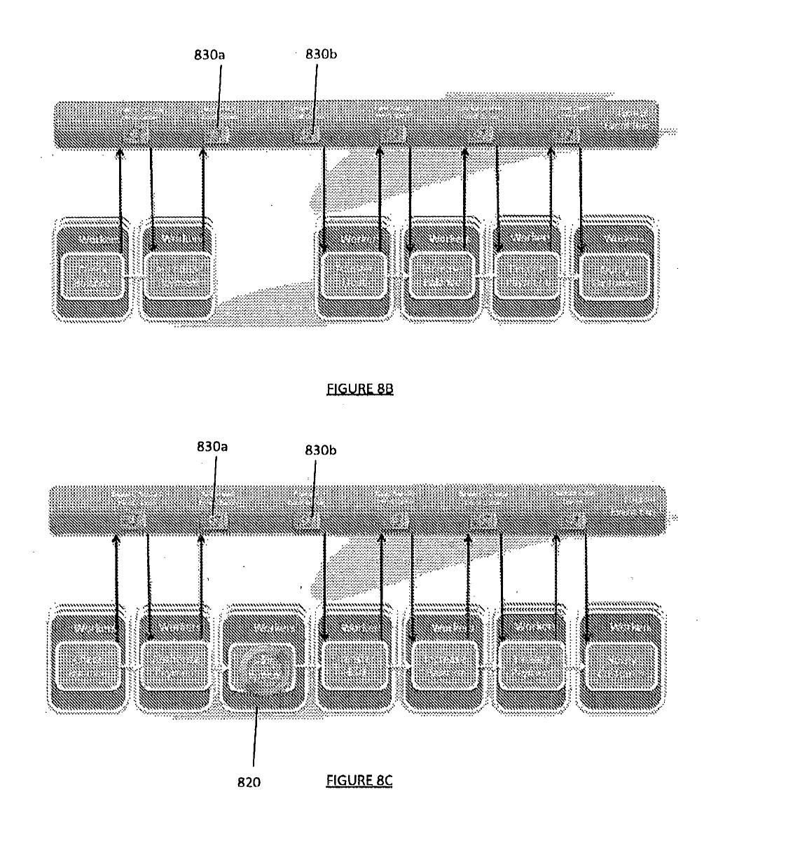

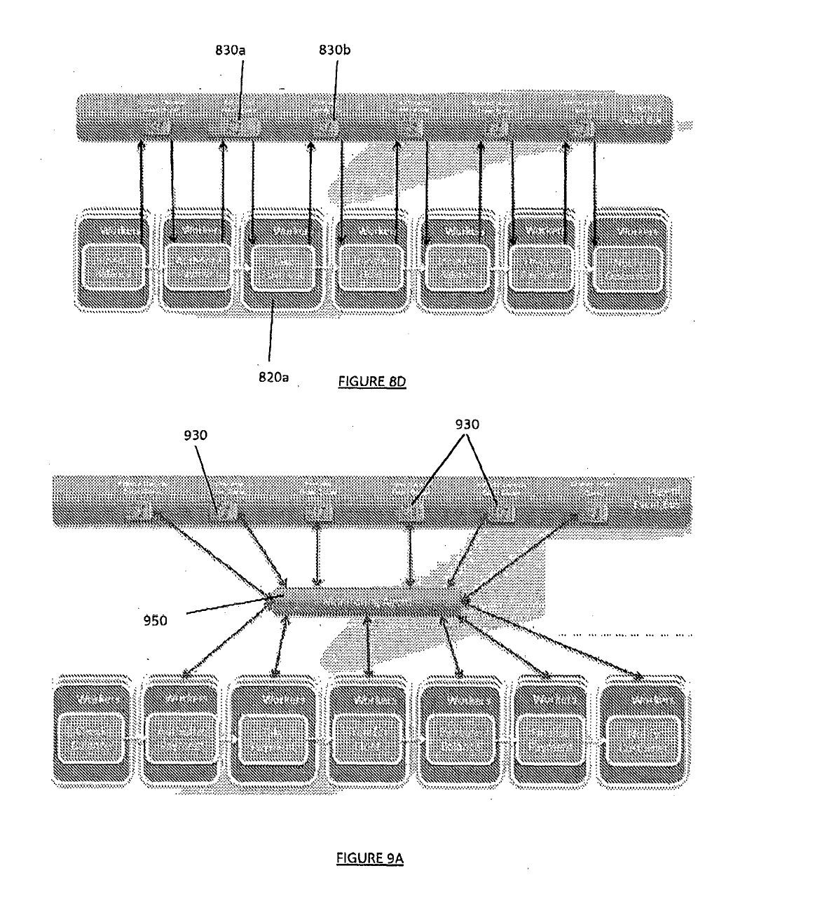

Referring to FIGS. 8A to 8D, when a node 820a has stopped processing due to some failure, the previous event node queue 830a fills up while the failed node 820 instances restart. At the same time the subsequent event node queues 830b drain while the failed node 820a instances restart. When the failed node 820a comes back online, they begin draining the previous node queue 830a and processing events.

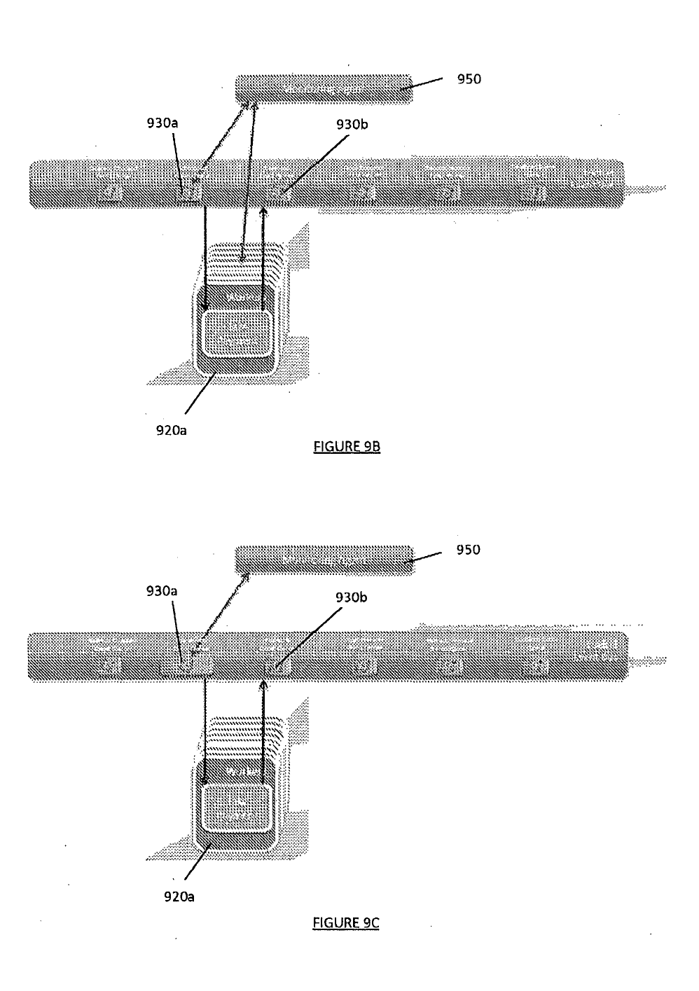

Referring to FIGS. 9A to 9C, the system will elastically scale computing resources to meet demand. A monitoring agent 950 will actively track event queue 930 lengths and worker utilisation. When transaction volumes increase and the downstream nodes 920b cannot keep up the previous event node queue 930a grows. The monitoring agent 950 detects this and instantiates more node workers 920a where required.

The previous node event queue 930a shrinks as the new Instantiated nodes 920a do their work, and the transaction volumes slow down. The monitoring agent 950 detects that the queue 930a has shrunk and the worker nodes 920a are under-utilised, and removes instances.

According to this embodiment, it is possible to only pay for the computing resources that are currently being used, but extremely fast access to more resources is available when needed. The system tunes itself and manual management is not needed. This makes the iPay system highly reliable and scalable and applicable to any cloud based transaction process business requirement (i.e. white goods application).

Unless the context requires otherwise or specifically stated to the contrary, integers, steps or elements of the invention recited herein as singular integers, steps or elements clearly encompass both singular and plural forms of the recited integers, steps or elements.

Throughout this specification, unless the context requires otherwise, the word “comprise”, or variations such as “comprises” or “comprising”, will be understood to imply the inclusion of a stated step or element or integer or group of steps or elements or integers, but not the exclusion of any other step or element or integer or group of steps, elements or integers. Thus, in the context of this specification, the term “comprising” is used in an inclusive sense and thus should be understood as meaning “including principally, but not necessarily solely”.

It will be appreciated that the foregoing description has been given by way of illustrative example of the invention and that all such modifications and variations thereto as would be apparent to persons of skill in the art are deemed to fall within the broad scope and ambit of the invention as herein set forth.

1. An electronic funds transfer system comprising:
at least one user account, each of which is associated with a user of the system;
at least one partner organisation account, each of which is associated with a partner organisation of the system;
a system administrator adapted to receive notification from said partner organisation of funds to be transferred to said user account;
a provider fund containing funds for financing transactions between said partner organisation and said user; and
a plurality of transaction processing nodes each of which is responsible for one distinct operation in the transaction process;
wherein said system administrator, on receiving an electronic funds transfer notification from a partner organisation, is adapted to directly or indirectly facilitate transfer of an allocated fund notified by said partner organisation to an allocated user account in real time in anticipation of receipt of the allocated fund by said provider fund from a partner organisation funds manager after clearance of the allocated fund from said partner organisation funds manager.

2. A system according to claim 1, wherein said system administrator is adapted to instruct a platform provider to effect the transfer of said allocated fund from said provider fund to said allocated user account.

3. A system according to claim 2, wherein said system administrator maintains a ledger of said user account and said partner organisation account.

4. A system according to of claim 1, wherein each said user of said system is allocated a credit card facility, preferably a debit card facility (i.e. prepaid credit card facility), associated with said user account to provide instant access to user funds held in said user account to said user.

5. A system according to claim 1, wherein said partner organisation funds manager is a financial institution having a funds clearance period of 24 hours or more.

6. A system according to of claim 1, wherein said transfer of said allocated fund to said allocated user account is substantially instantaneous on receipt of said electronic funds transfer notification from said partner organisation.

7. A system according to claim 1, wherein said provider fund contains an amount of funds dependent on the overall volume of transactions that occur, or that are expected to occur within the system, and/or wherein if said provider fund is depleted said system defers transfer of said allocated fund notified by said partner organisation to said allocated user account until clearance of said allocated fund from said partner organisation funds manager.

8. A system according to claim 1, further comprising a monitoring agent operable to adjust computing resources of each of said transaction processing nodes according to a load thereof.

9. A system according to claim 1, wherein said nodes communicate indirectly via a high speed event bus.

10. A system according to claim 9, wherein said Event Bus is logical, preferably composed of a set of Windows Azure Service Bus Queues.

11. A method for electronic transfer of funds comprising:
notifying a system administrator of an electronic funds transfer from a partner organisation to an allocated user account;
transferring an allocated fund notified by said partner organisation from a provider fund to said allocated user account in real time in anticipation of receipt of said allocated fund by said provider fund from a partner organisation funds manager; and
transferring an amount corresponding to said allocated amount to said provider fund from said partner organisation funds manager after clearance of said allocated fund from said partner organisation funds manager
wherein each distinct operation during transaction processing is processed by an independent transaction processing node, wherein when a node finishes its processing it fires an event to invoke the next node in the transaction processing.

12. A method according to claim 11, wherein on receiving notification of the electronic funds transfer said system administrator instructs a platform provider to effect the transfer of the allocated funds from said provider fund to said allocated user account

13. A method according to claim 11, wherein said transfer of said allocated fund to said allocated user account is substantially instantaneous on receipt of said electronic funds transfer notification from said partner organisation.

14. A method according to claim 11, wherein said partner organisation funds manager is a financial institution having a funds clearance period of 24 hours or more.

15. A method according to claim 11, further comprising adjusting computing resources of each independent transaction processing node according to a load thereof.

16. A method according to claim 15, wherein said nodes communicate indirectly via a high speed event bus.

17. A method of administering an electronic transfer of funds comprising:
receiving notification of an electronic funds transfer from a partner organisation to an allocated user account; and
instructing a platform provider to effect the transfer of an allocated fund notified by said partner organisation from a provider fund to said allocated user account in anticipation of receipt of said allocated fund by said provider fund from a partner organisation funds manager,
whereby said allocated fund is credited to said allocated user account in real time
wherein each distinct operation during transaction processing is processed by an independent transaction processing node, wherein when a node finishes its processing it fires an event to invoke the next node in the transaction processing.

18. A method according to claim 17, wherein said allocated fund is credited to said allocated user account 24 hours or more prior to clearance of said allocated fund by said partner organisation funds manager.

19. A method according to claim 17, additionally comprising maintaining a ledger of said user account.

20. A method according to claim 17, further comprising adjusting computing resources of each independent transaction processing node according to a load thereof.

21. A method according to claim 20, wherein said nodes communicate indirectly via a high speed event bus.
